(19) United States
(12) Patent Application Publication
(10) Pub. No.: US 2020/0052253 A1
(43) Pub. Date: Feb. 13, 2020

(54) METHOD FOR THE PRODUCTION OF AN ENERGY STORE, AND ENERGY STORE

(71) Applicant: FIBERDRAFT E.U., Bruck an der Mur (AT)

(72) Inventor: Oliver UREM, Bruck an der Mur (AT)

(21) Appl. No.: 16/492,701

(22) PCT Filed: Mar. 14, 2018
(86) PCT No.: PCT/EP2018/056435

§ 371 Date: Sep. 10, 2019

(30) Foreign Application Priority Data
Mar. 24, 2017 (AT) A 50238/2017

(51) Int. Cl. H01M 2/10

(52) U.S. Cl. CPC H01M 2/1016; H01M 2/1094

(57) ABSTRACT

Disclosed are a method for producing an electric energy store as well as an energy store including at least two storage cells. In the disclosed method, the storage cells are first stacked to form a cell stack, whereupon a cover of the energy store is formed by laminating covering material around the cell stack.

The invention relates to a method for the production of an energy storage and an energy storage.

Since electric energy storages are used, there is also the need to use the latter in a wide variety of environments. In particular, wetness represents a major obstacle in doing so. Efforts to provide a battery that is suitable for the use on submarines, and hence is water tight, are for example shown in U.S. Pat. No. 1,027,088 A which was already published in 1912. At the same time this document also illustrates the basic problem in the production of electric energy storages that are protected against environmental influences. However, housings are required to protect the energy storages, which in practice are in most cases inflexible and, depending on material selection, also heavy. In addition, under certain circumstances separate devices must be provided within such a housing in order to regulate the temperature in the housing. With certain types of energy storages, moreover, cell degassing can occur. In order to discharge these gases systematically or to compensate for the pressure increase, further mechanisms are needed. Such mechanisms, which are usually used in pressure compensation, in turn represent a possible weak spot in the seal of the energy storage.

The object of the invention is therefore to overcome the above-described drawbacks and to make available an improved energy storage that is suitable for use in unfavorable conditions.

This object is achieved according to the invention by a method for the production of an energy storage with the features of claim 1 and an energy storage with the features of claim 8.

Instead of storing multiple cell stacks in a large, joint housing as before, like it is handled in the state of the art, each cell stack is laminated separately, whereby the cells are mechanically held together by laminating and at the same time a cladding is formed. In contrast to the methods in which the cladding is already prefabricated, an essentially gap-free encasing can be ensured according to the invention. In addition, the individual cell stacks no longer necessarily have to be placed at the same site and/or in a specified arrangement to one another.

According to a preferred embodiment and implementation of the invention or the method according to the invention, possible air pockets or gaps between the individual storage cells and/or the cladding are eliminated. This can be carried out via the process of the application of the cladding and/or by the use of a filler.

By eliminating air pockets, the outgassing of the storage cells can be counteracted and the use of means for compensation of the atmospheric pressure fluctuations that adversely affect the integrity of the cladding can thus be avoided.

Another major advantage of an energy storage that is manufactured according to the invention is the small size in which the latter can be made. Due to the elimination of a large, joint housing, the individual energy storages can be freely distributed in their position. This is especially advantageous in the case of vehicles and aircraft of all types.

Thus, for example, in a hybrid or electric car, a large storage block, which, for example, adversely affects the trunk space, is no longer necessary; rather, the individual energy storages can advantageously be distributed in the vehicle, for example over the wheels.

A distribution of the energy storage is also especially advantageous in the case of electrically-driven aircraft or drones. Flight stability can be positively influenced by the less restricted weight distribution.

Especially advantageous is the use of energy storages that are manufactured according to the invention in water vehicles. The waterproof and in this case is simultaneously as space-saving and as flexible as possible construction makes it possible to store/install the energy storage directly in the keel. Bilge water that is usually collected here (for example by rain, seepage, or trickling condensate) in general has a temperature of over 0° C. and under 30° C. When stored in bilge water, the energy storages are subsequently heated or cooled to precisely this temperature range, which represents ideal conditions for the majority of the usual storage cells.

If a filler is introduced into the cladding or the cell stack, the latter can have various additional properties, which have a positive effect on the energy storage. These properties can each be advantageous individually but also in various combinations. An advantageous combination of these properties can be selected by one skilled in the art corresponding to the requirements on the energy storage. Below, some especially preferred and advantageous variants are explained.

In a first preferred variant of the invention, the filler is has good heat-conductivity, i.e., it has a heat conductivity of at least 0.7 W/mK. This embodiment is in particular advantageous for transporting heat from the interior of the cell stack to the outside. This property of the filler can be especially advantageous when the energy storage itself is located in a material with good heat-conductivity, such as, for example, in the above-mentioned bilge water.

In another preferred embodiment of the invention, the filler is designed as an optionally mechanically-stabilizing, one-part or multi-part jacket. This embodiment is then especially advantageous, for example, when the storage cells are cells that are susceptible to deformation, such as, for example, pouch cells. A possible combination of various properties can be realized in this case, for example, when the jacket is manufactured from a cross-linking 2-component silicone elastomer and optionally also extends between the cells. For example, silicone elastomers that have a heat conductivity of over 3 W/mK are known. Embodiments in which a jacket and a separate filler are combined are also conceivable.

In another preferred embodiment of the invention, the storage cells can also be cast within the filler. Fillers may be, for example, non-cross-linking, one-component heat-conductive pastes. This is especially advantageous in the case of storage cells with cylindrical or prismatic shapes, such as, for example, round cells or prismatic cells, since the manufacturing of an appropriate jacket that also extends into the intermediate spaces can be associated with high costs.

Of course, a cast filler can also have a high heat conductivity and/or can harden into a stabilizing element.

According to another preferred further development of the invention, the thickness of the filler is changeable. Thus, possible changes in the volume of the storage cells can be compensated for during use.

Additional advantageous and preferred improvements of the invention can be produced by means of the cladding or during laminating of the cladding. These positive and advantageous embodiments and implementations, too, can be combined by one skilled in the art.

According to a first advantageous implementation of the invention, the laminating is carried out at temperatures below 100° C., in particular below 50° C., preferably below 25° C. With laminating at especially low temperatures, damage to the storage cells is avoided, which increases the service life of the finished energy storage. An implementation example for laminating under 25° C. is, for example, laminating with use of UV-hardening epoxide resin.

According to another preferred embodiment, the cladding is electrically-insulating. This is important, on the one hand, for operational safety, and, on the other hand, in case of an impact, for example, the cell stacks can be deformed or squeezed. In the case of conventional cell stack housings made of aluminum, this often results in dangerous cell short circuits, which can trigger a battery fire. Because of the avoidance, within the scope of the invention, of metal materials in the housing, this danger is eliminated to a great extent. Another measure for the protection of storage cells can be to provide an electrically-conductive layer in the cladding. This acts as a shield relative to electrical and electromagnetic interferences, i.e., as an electromagnetic compatibility measure. This protective measure can be implemented by, for example, the incorporation of a conductive fiber tissue (e.g., carbon fiber), a metallic mesh, a film or a conductive varnish. To this end, either the cladding material can be manufactured in multiple layers or the laminating is carried out in multiple layers, one of which contains the conductive material.

In an especially preferred embodiment of the invention, the cladding contains a fiber-reinforced plastic, in particular a glass-fiber, carbon-fiber, aramid-fiber, silicon-fiber, hemp-fiber, basalt-fiber, boron-fiber, ceramic-fiber, quartz-fiber, silicic-acid-fiber, polyester-fiber, nylon-fiber, PE-fiber, PMMA-fiber, flax-fiber, wood-fiber, sisal-fiber, PPBO-fiber, or blended-fiber plastic. Fiber-reinforced plastics are especially advantageous for the method according to the invention or the energy storages according to the invention, since they can be easily laminated and at the same time have great strength at low weight. Thus, both the service life of the battery and safety during operation of the battery can be influenced positively.

In another preferred embodiment, the cladding can also be configured to be partially thermally insulating. This way it is possible to keep cells at the edge of the stack from being cooled significantly better than cells further inward. This can be advantageous when uneven cooling can lead to uneven strain, charging and/or discharging of storage cells, which can be disadvantageous for the long-term operation of the energy storage.

Additional preferred embodiments of the invention are the subject matter of the other subclaims.

Below, preferred embodiments of the invention are described in more detail based on the drawings. The same components in various embodiments are in this case provided with the same reference numbers for the sake of clarity. Here, in partially heavily schematized depiction:

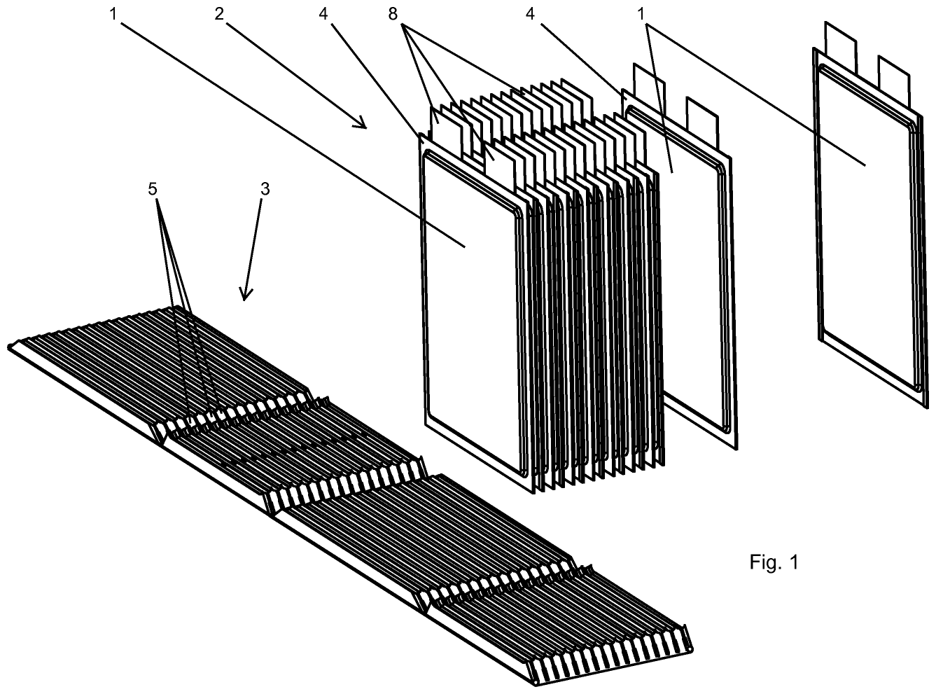

FIG. 1 shows an embodiment of the invention, in which pouch cells as storage cells are stacked on one another in a first variant of a cell stack,

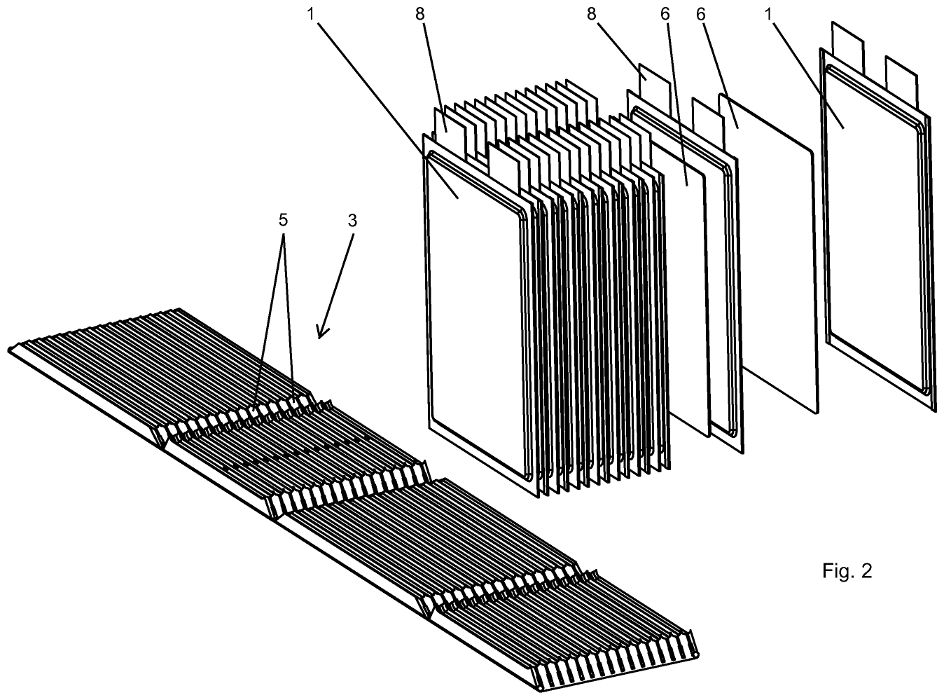

FIG. 2 shows a further development of the embodiment of FIG. 1, in which an additional filler is located between the pouch cells,

FIG. 3 shows a cell stack corresponding to FIG. 1 or FIG. 2 with a jacket that is placed around the cell stack,

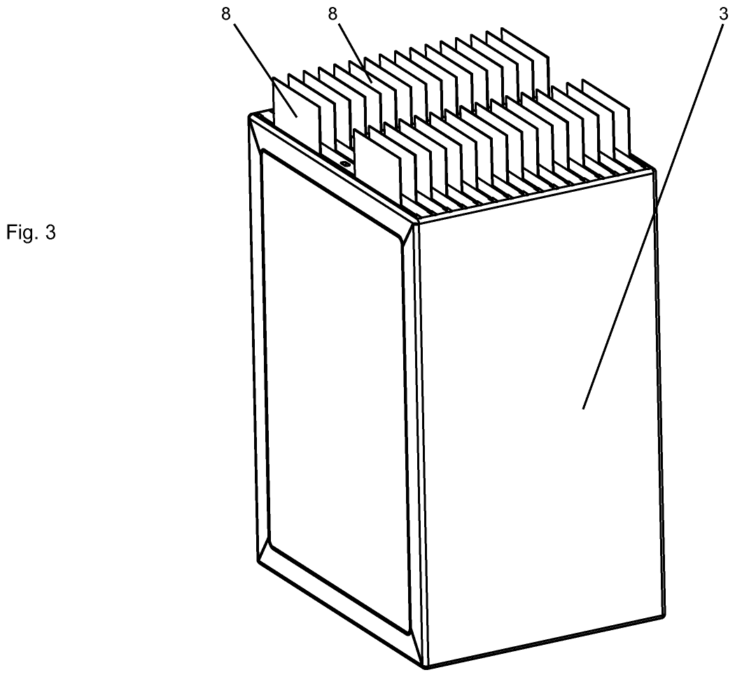

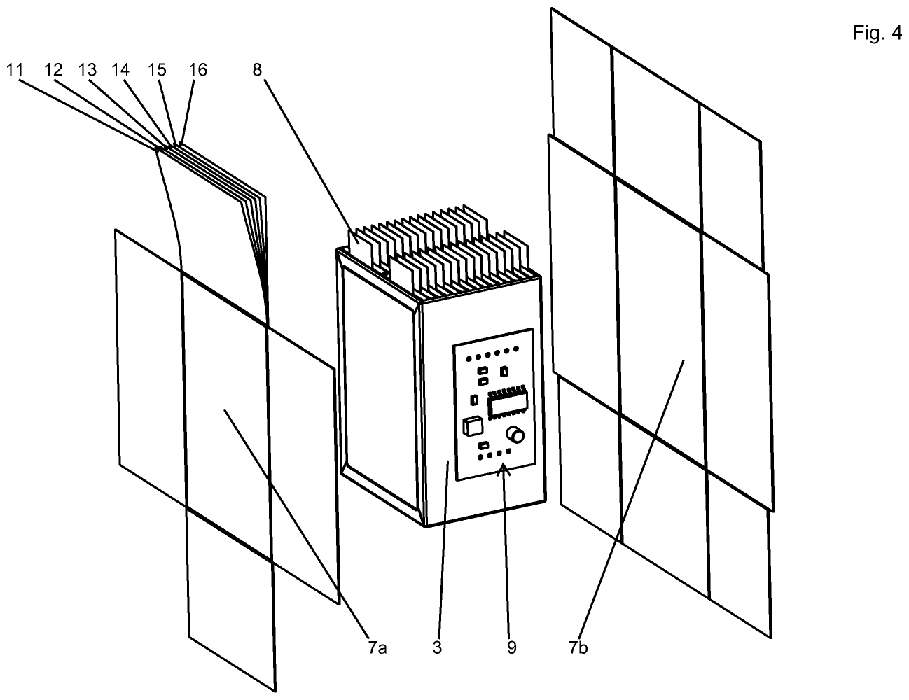

FIG. 4 shows the cell stack of FIG. 3 with electronics and a cladding material that is depicted symbolically, has multiple layers, and is ready for laminating,

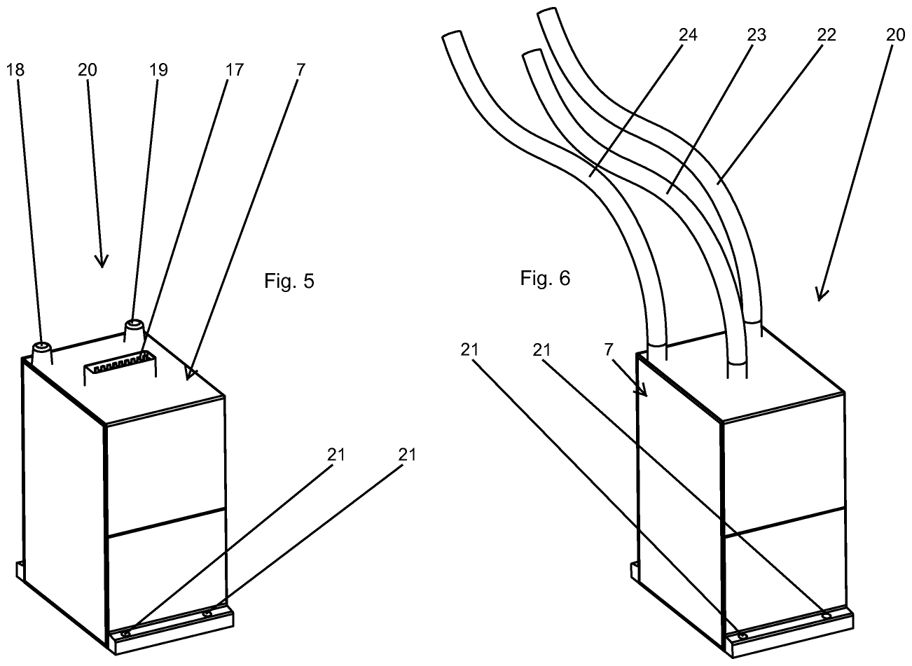

FIG. 5 shows a first embodiment of a finished laminated energy storage,

FIG. 6 shows a second embodiment of a finished laminated energy storage,

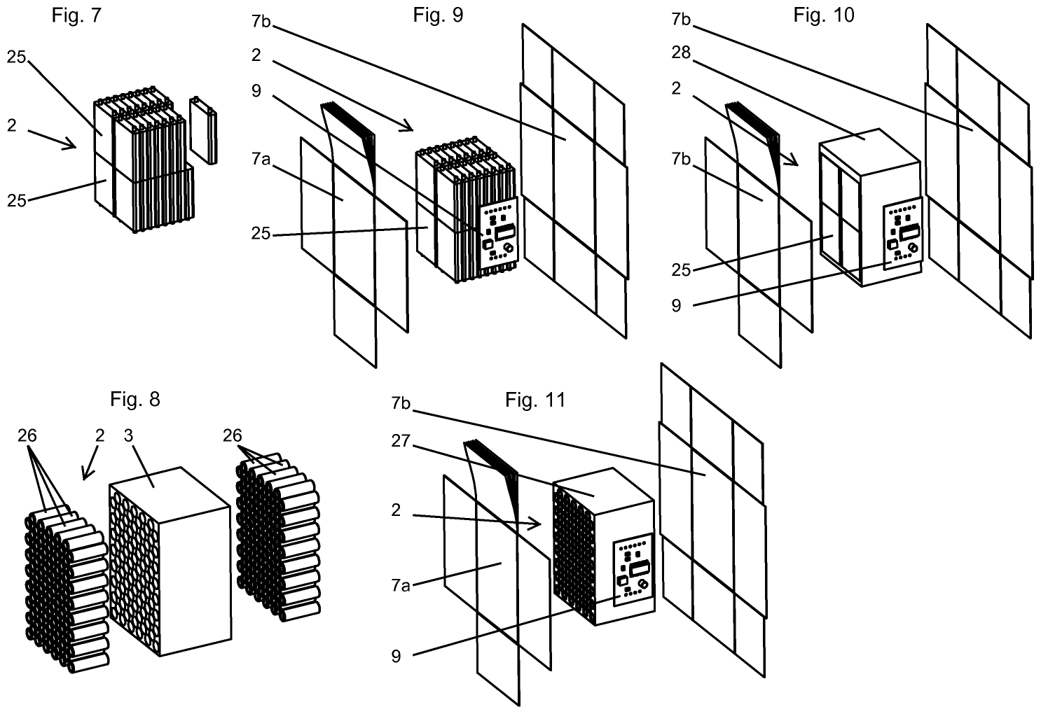

FIG. 7 shows another embodiment of the invention, in which prismatic cells are stacked on one another in a second variant of a cell stack,

FIG. 8 shows another embodiment of the invention, in which round cells are stacked on one another in a third variant of a cell stack,

FIG. 9 shows the cell stack of FIG. 7 with electronics and a cladding material that is depicted symbolically, has multiple layers, and is ready for laminating,

FIG. 10 shows the cell stack of FIG. 7 with electronics, a cladding material that is depicted symbolically, has multiple layers, and is ready for laminating, and an additional jacket,

FIG. 11 shows the cell stack of FIG. 8 with electronics and a cladding material that is depicted symbolically, has multiple layers, and is ready for laminating,

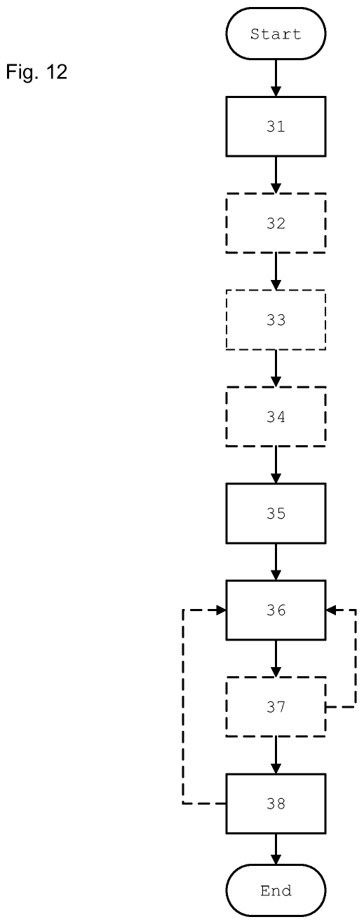

FIG. 12 shows a possible sequence of events of a method according to the invention based on a flow chart,

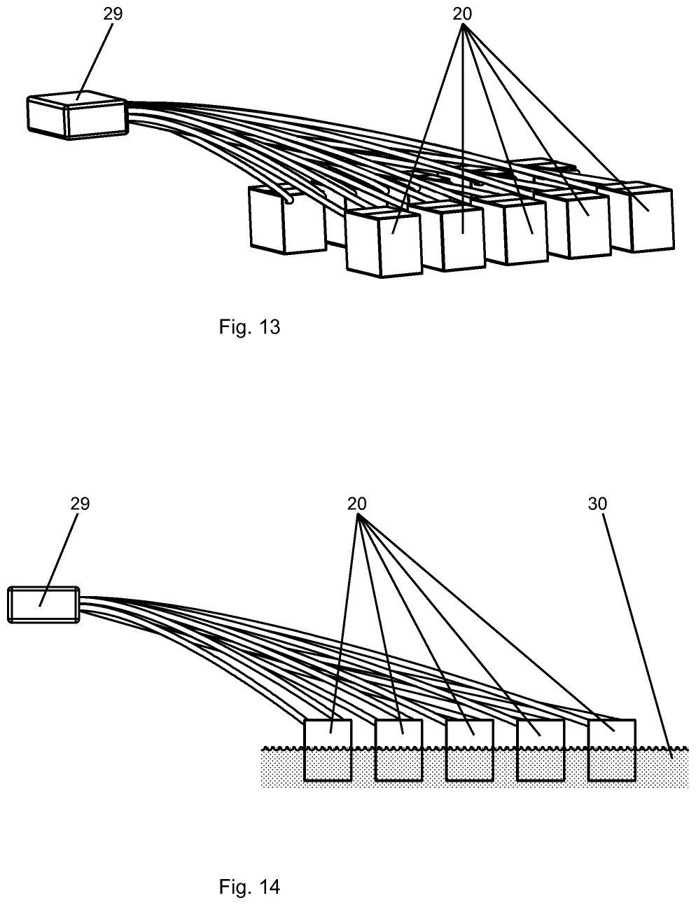

FIG. 13 shows an energy storage system with multiple energy storages according to the invention, and

FIG. 14 shows a side view of the energy storage system of FIG. 13, in which the energy storages are arranged in a cooling/heating medium.

FIG. 1 shows an embodiment of the invention, in which pouch cells as storage cells 1 are stacked on one another in a first variant of a cell stack 2. A jacket 3 can then be placed around the cell stack 2 as filler.

For the configuration of the jacket 3, some essential properties of pouch cells were taken into consideration. On the one hand, the latter in general have an edge 4, at which two wall films of a bag (=pouch), which forms an outside wall of the pouch cell, are welded to one another. On the other hand, pouch cells are easily deformable because of their design with a flexible outside skin, which under certain circumstances can lead to damaging of the storage cells 1.

Independently of the type of selected storage cells, it is additionally advantageous when good heat removal is provided, since otherwise a so-called thermal runaway can occur in the operation of the energy storage.

The jacket 3 that is depicted in FIG. 1 therefore has ribs 5, between which the edges 4 can be arranged. The jacket 3 can thus provide stability to the storage cells 1. In addition, the jacket 3 is has good heat-conductivity as filler, so that heat from the storage cells can be transported outward.

If, as depicted in FIG. 2, an additional filler 6 is arranged between the storage cells 1, heat that is produced during operation can be dissipated even better. In this respect, it is advantageous when the filler 6 is also has good heat-conductivity. In terms of the invention, “has good heat-conductivity” is defined as thermal conductivity of at least 0.7 W/mK.

The filler 6 that is depicted in FIG. 2 is made in the form of matting. However, it could also be applied between the individual storage cells 1, for example in paste-like form. Within the scope of the invention storage cells 1 that are stacked on one another with intermediate elements as filler 6, as shown in FIG. 2, also form a cell stack 2.

Another advantageous property, which can be preferably selected for filler 6 that is arranged between the storage cells 1, is elastic compressibility. Thus, fluctuations in the volume of the storage cells 1 that are produced during operation can be compensated for, without a cladding 7 (see, for example, FIG. 4) of the energy storage (see, for example, FIG. 5) being elastically manufactured. In this case, the filler in addition acts as a buffer between the storage cells.

FIG. 3 shows the cell stack 2 of FIG. 1 or FIG. 2 with the jacket 3 that is placed around the cell stack. It can be seen that contacts 8 of the storage cells 1 project out from the latter through recesses in the jacket 3. The latter can be provided later with connections and/or can be connected with electronics 9 (depicted symbolically in FIG. 4).

The electronics 9 can contain both circuits that have to do directly with the use of the energy storage, such as, for example, inverters or a load control, and circuits that, for example, monitor and/or storage the state of the energy storage, such as, for example, electronics for monitoring the temperature or the charging state of the energy storage. Electronics for monitoring the energy storage can also have corresponding sensors, such as, for example, temperature probes or pressure sensors. Means to storage correspondingly store collected data and/or to read or to transmit data via a wired or wireless connection can also, of course, be provided. For a cladding that is as tight as possible, wireless transmission methods may be preferred.

In addition, FIG. 4 shows two cladding elements 7a, 7b of a cladding 7 (FIG. 5), which are consequently laminated around the cell stack 2. The cladding 7 can have multiple layers with various properties. This can be carried out, as depicted by way of example on the cladding element 7a in FIG. 4, in such a way that the cladding elements 7a, 7b have multiple layers 11 to 16 and/or that the cladding 7 is manufactured successively from multiple layers of cladding elements.

A multi-layer construction of the cladding 7 can be used for various advantageous properties, since for the various layers, different materials with different respective properties that are each advantageous per se and complement one another can be selected.

For example, it is advantageous when the cell stack 2 and optionally the electronics 9 are electrically insulated relative to the environment. Simultaneously, however, a shielding against electromagnetic fields is also desirable in order to protect the electronics from disruptions or so as not to emit forwarded electromagnetic noise fields. Either one can be procured simultaneously in the case of a multi-layer configuration of the cladding 7, when, for example, an inner layer, i.e., lying nearer in the storage cells, is electrically insulating and another farther outward-lying layer contains, for example, a metal wire cloth, which acts as a Faraday cage.

In addition, individual layers 11 to 16 can be used in order to protect the stability of the cladding 7 against various influences. Thus, an outermost layer 11 can be manufactured from, for example, a material that is especially resistant to UV radiation or salt water.

Farther inward-lying layers can have, for example, tissues that protect the cladding 7 against puncturing by sharp or pointed objects. This is important in particular when the storage cells 1 are pouch cells, since the latter do not have any protection against such damage. If, for example, a pouch cell is at least partially punctured by a sharp edge, damage of the separator inside the pouch cell can result. This causes an acceleration of the exothermic reaction inside the pouch cell, whereupon the heat that is produced can no longer be adequately removed. Consequently, a runaway of the cell can occur, which can lead to explosions and fires.

FIG. 5 shows a first embodiment of a finished energy storage 20 with a cladding 7 that is laminated around the cell stack 2 and the electronics 9. Connections 17, 18, 19, e.g., in the form of plugs, can be seen on the top of the energy storage. Energy can be fed to or removed from the energy storage via the connections 18, 19. In addition, there is a connection 17, via which it can be communicated with the electronics 9 in order to read out, for example, the status of the energy storage 20 or to control the charging and/or discharging of the energy storage 20. In this case, all connections 17, 18, 19 are tightly laminated into the cladding 7.

In the embodiment depicted in FIG. 5, mounting aids 21 are arranged in the lower area of the energy storage 20. In addition to the depicted recesses, for example for screws, the latter can also have other shapes. Thus, for example, hooks or projections, which engage into counterparts at the mounting site, are conceivable. A selection of form and position of such assembling aids 21 can be selected by one skilled in the art corresponding to the application of the energy storage. If the assembling aids 21, as provided according to a preferred further development of the invention, are laminated into the cladding 7, the position of the assembling aids 21 on the cladding 7 can be selected freely, since the latter must not be oriented to or fastened onto structures inside the cladding.

FIG. 6 shows a second embodiment of a finished, laminated energy storage 20. In the latter, the connections are designed in the form of cables 22, 23, 24. This embodiment is primarily especially advantageous when the energy storage 20 is to be mounted and/or stored in an environment that is especially harmful for the connections, such as, for example, in the bilge water of a boat.

FIG. 7 shows another embodiment of the invention, in which storage cells 25 are stacked in a second variant of a cell stack. In this embodiment, the storage cells 25 are prismatic cells.

A third alternative embodiment of the invention is shown in FIG. 8. In the latter, the storage cells 26 are round cells. The jacket 27 is accordingly manufactured in this form as a block with recesses for the round cells. Embodiments in which a paste-like or liquid, optionally hardening, filler is applied between the round cells are, of course, also conceivable.

FIG. 9 and FIG. 10 show the embodiment of FIG. 7 with the electronics 9 and the cladding elements 7a, 7b that are ready for laminating. In the embodiment of FIG. 10, in this case analogously to the embodiments of FIG. 1 to FIG. 4, a jacket 28 is placed around the cell stack 2.

FIG. 11 shows the embodiment of FIG. 8 with the electronics 9 and the cladding elements 7a, 7b that are ready for laminating.

In FIG. 12, a possible procedure of a method according to the invention for producing an energy storage is illustrated based on a flow chart. Some steps of the method according to the invention can also be carried out in another order and can be freely selected by one skilled in the art without departing from the actual invention.

In a first step 31, storage cells are stacked on one another to form a cell stack. In a second step 32, a filler is applied between the storage cells, and then, in a third step 33, a jacket is placed around the cell stack. If a liquid or paste-like filler is involved, it can also be useful first to place a jacket around the cell stack and then to introduce the filler. In this case, the jacket could be used, for example, as a frame for pouring the filler. In principle, these two steps are optional, since it is also possible according to the invention to produce an energy storage without a jacket and/or filler (cf. also FIG. 9).

In a fourth step 34, electronics of the energy storage are arranged on the cell stack and/or on the jacket or filler. This step is optional, since the electronics can also be housed separately from the energy storage, for example in a control unit, which optionally also monitors and/or controls multiple energy storages.

In a fifth step 35, the connections of the storage cells are arranged and prepared for the laminating. This step can also comprise the connection with the electronics.

The sixth step 36, the seventh step 37, and the eighth step 38 comprise the laminating and hardening of the cladding with the optional intermediate step of the introduction or application of possible intermediate layers, assembly systems and the like. These steps can be repeated according to the discretion of one skilled in the art. Depending on which media, in particular resins, are selected for laminating, it may be necessary for a hardening step to be already carried out between individual laminating processes. It is essential that the cladding be produced first in the course of the laminating or the repeated laminating processes and thus a gap-free and tight enclosing of the cell stack be ensured.

FIG. 13 shows an isometric view of an energy storage system in which multiple cell stacks 2 that are recombined to form energy storages 20 and are laminated are arranged in a suitable way, and the connections 22 to 24 are combined to form an electronics box 29. If all electronics 9 required for the operation of the energy storages 2 have already been installed in the energy storages, a consumer can be arranged instead of the electronics box 29 even at this point.

FIG. 14 shows a side view of the energy storage system of FIG. 13, in which the energy storages 2 are arranged in a cooling/heating medium 30, for example water. Because of the tightly-sealed cladding of the energy storage, the energy storages are kept from being damaged by the cooling/heating medium 30, and the cooling/heating medium 30 is kept from being contaminated by possible contents of the energy storages 1. Thus, for the cooling/heating medium 30, substances can also be used that are in contact with the environment or that can be exchanged with the latter, such as, for example, sea water or river water on a boat.

### LIST OF REFERENCE SYMBOLS

1 Storage cells (pouch cells)
2 Cell stack
3 Jacket (for pouch cells)
4 Edge
5 Ribs
6 Filler
7 Cladding
7a, 7b Cladding elements
8 Contacts
9 Electronics
10 Free
11-16 Layers (of the cladding)
17-19 Connections
20 Energy storage
21 Mounting aid
22-24 (Alternative) connections
25 Storage cells (prismatic cells)
26 Storage cells (round cells)
27 Jacket (for round cells)
28 Jacket (for prismatic cells)
29 Electronics box
30 Cooling/heating medium (water)
31 To stack and electrically connect storage cells into a cell stack
32 (Optional) to introduce filler
33 (Optional) to install the jacket
34 (Optional) to arrange electronics
35 To arrange connections
36 Laminating
37 (Optional) to apply assembly systems/intermediate layers
38 Hardening

1. Method for producing an electric energy storage (20) with at least two storage cells (1), whereby the storage cells (1) are first stacked to form a cell stack (2), wherein a cladding (7) of the energy storage (20) is formed by laminating cladding material around the cell stack (2).

2. Method according to claim 1, wherein before the laminating, air pockets between the storage cells (1) of the cell stack (2) and/or between the cladding material and the cell stack (2) are removed or filled.

3. Method according to claim 1, wherein before the laminating, the cell stack (2) is provided with a filler (6) at least partially.

4. Method according to claim 3, wherein the filler (6) is designed as a jacket (3).

5. Method according to claim 3, wherein the filler (6) has a thermal conductivity of at least 0.7 W/(m*K).

6. Method according to claim 3, wherein the storage cells (1) are cast into the filler (6).

7. Method according to claim 1, wherein the laminating and the hardening of the laminate is carried out at temperatures under 100° C., in particular under 50° C.

8. Energy storage (20) with a cell stack (2) that consists of at least two storage cells (1), whereby the energy storage (20) is surrounded by a cladding (7), wherein the cladding (7) is a cladding (7) that is laminated around the cell stack (2).

9. Energy storage (20) according to claim 8, wherein the cladding (7) encloses the cell stack (2) in an airtight and watertight manner.

10. Energy storage (20) according to claim 8, wherein connections (17, 18, 19) of the energy storage (20) are laminated into the cladding (7).

11. Energy storage (20) according to claim 8, wherein a one-part or multi-part thermal jacket (3) is arranged inside the cladding layer at least in partially around the cell stack (2).

12. Energy storage (20) according to claim 11, wherein the thermal jacket (3) has a heat conductivity of at least 0.7 W/(m*K).

13. Energy storage (20) according to claim 11, wherein the thermal jacket (3) is electrically insulating.

14. Energy storage (20) according to claim 11, wherein the thermal jacket (3) is elastically compressible.

15. Energy storage (20) according to claim 11, wherein the thermal jacket (3) consists of hydrophobic material.

16. Energy storage (20) according to one claim 8, wherein a heat-conductive paste is located between the storage cells (1).

17. Energy storage (20) according to claim 8, wherein a buffer, in particular a matting or a foam, is located between the storage cells (1).

18. Energy storage (20) according to claim 8, wherein mounting systems of the energy storage are integrated into the cladding (7), in particular laminated in.

19. Energy storage (20) according to claim 8, wherein the cladding (7) contains a fiber-reinforced plastic, in particular a glass-fiber, carbon-fiber, aramid-fiber, silicon-fiber, hemp-fiber, basalt-fiber, boron-fiber, ceramic-fiber, quartz-fiber, silicic-acid-fiber, polyester-fiber, nylon-fiber, PE-fiber, PMMA-fiber, flax-fiber, wood-fiber, sisal-fiber, PPBO-fiber, or blended-fiber plastic.

20. Energy storage (20) according to claim 8, wherein the cladding (7) contains a flame-retardant material.

21. Energy storage (20) according to claim 8, wherein the cladding (7) is partially heat-insulating.

22. Energy storage (20) according to claim 8, wherein the cladding (7) is electrically-insulating.

23. Energy storage (20) according to claim 8, wherein the energy store has electronics (9).

24. Energy storage (20), wherein the energy storage is manufactured according to a method according to claim 1.
